(19) United States
(12) Patent Application Publication
(10) Pub. No.: US 2026/0077279 A1
(43) Pub. Date: Mar. 19, 2026

(54) FILTER SYSTEM WITH AT LEAST TWO FILTER ELEMENTS, FILTER ELEMENT, AND USE

(71) Applicant: MANN+HUMMEL GmbH, Ludwigsburg (DE)

(72) Inventors: Daniel SCHMID, Sachsenheim (DE); Thilo MÜLLER, Rutesheim (DE)

(21) Appl. No.: 19/397,304

(22) Filed: Nov. 21, 2025

Related U.S. Application Data
(63) Continuation of application No. PCT/EP2024/063212, filed on May 14, 2024.

(30) Foreign Application Priority Data
Jun. 6, 2023 (DE) 10 2023 114 764.1

(51) Int. Cl. B01D 29/07; B01D 35/30

(52) U.S. Cl. CPC B01D 29/07; B01D 35/30; B01D 2201/304; B01D 2201/34

(57) ABSTRACT

A filter system including at least two exchangeable filter elements, each including a filter body including a filter medium arranged so as to allow passage of a fluid in a flow direction for flow-through. At least one of the filter elements includes an axially projecting lateral strip which in an axial direction projects past an end face of the one of the filter elements, wherein the other one of the filter elements includes at an end face a circumferentially extending seal with a groove and wherein the end face of the other one of the filter elements is arranged adjacent to the end face of the one of the filter elements. When the filter elements are assembled as intended, the axially projecting lateral strip of the one of the filter elements engages the groove of the seal of the other one of the filter elements.

### CROSS-REFERENCE TO RELATED APPLICATIONS

This application is a continuation application of international application No. PCT/EP2024/063212 having an international filing date of May 14, 2024, and designating the United States, the international application claiming a priority date of Jun. 6, 2023, based on German patent application No. 10 2023 114 764.1, the entire contents of the aforesaid applications being incorporated herein by reference.

### TECHNICAL FIELD

The invention concerns a filter system with at least two exchangeable filter elements for filtering a fluid, for example for filtering air, as well as a filter element for filtering a fluid, for example air, for such a filter system. Furthermore, an advantageous use is disclosed.

### BACKGROUND

Fuel cell systems often require a particle filter and an adsorption filter in order to filter particles as well as harmful gases out of the intake air. In this context, the filter bodies often have different service lives; this makes separation of the two filter bodies or filter elements expedient so that the filter elements may be exchanged separately. In this way, servicing costs may be saved. The filter elements are often configured as flat filters, for example; however, other filter element shapes are possible also.

### SUMMARY

It is an object of the invention to provide an easy-to-service and inexpensive filter system with at least two exchangeable filter elements for filtering a fluid, for example for filtering air.

A further object is providing a filter element for such an easy-to-service and inexpensive filter system.

The aforementioned object is solved according to an aspect of the invention by a filter system including a filter housing with a fluid inlet and a fluid outlet, and including at least two exchangeable filter elements for filtering a fluid, for example for filtering air, which are arranged between the fluid inlet and the fluid outlet, wherein the filter elements each include a filter body including a filter medium which, when in use as intended, are arranged so as to allow passage of the fluid therethrough in a flow direction for flow-through, wherein at least one of the filter elements includes a lateral strip which in axial direction projects past an end face of this filter element, wherein another one of the filter elements includes at an end face a circumferentially extending seal provided with a groove, which is arranged radially outside of its outer edges, wherein the end face is arranged adjacent to the first mentioned one of the filter elements, wherein, upon intended assembly of the filter elements in the filter housing, the axially projecting lateral strip of the first mentioned one of the filter elements engages the groove of the seal of the other one of the filter elements.

The further object is solved, on the one hand, by a filter element for filtering a fluid, for example air, for a filter system, including a filter body including a filter medium which, when in use as intended, is arranged so as to allow passage of the fluid therethrough in a flow direction for flow-through, wherein the filter body includes at an end face at outer edges a circumferentially extending seal with a groove in which, upon intended assembly, a lateral strip engages which projects at outer edges of an end face of another filter element.

The further object is solved, on the other hand, by a filter element for filtering a fluid, for example air, for a filter system, including a filter body including a filter medium which, when in use as intended, is arranged so as to allow passage of the fluid therethrough in a flow direction for flow-through, wherein the filter element includes a circumferentially extending lateral strip which projects past an end face of the filter element in axial direction.

Embodiments and advantages of the invention result from the following description and the accompanying drawings.

According to an aspect of the invention, a filter system is proposed, including a filter housing with a fluid inlet and a fluid outlet, and including at least two exchangeable filter elements for filtering a fluid, for example for filtering air, which are arranged between the fluid inlet and the fluid outlet. The filter elements each include a filter body including a filter medium which, when in use as intended, are arranged so as to allow passage of the fluid therethrough in a flow direction for flow-through. In this context, at least one of the filter elements includes a lateral strip which, in axial direction, projects past an end face of this filter element, wherein another one of the filter elements at an end face includes a circumferentially extending seal with a groove which is arranged radially outside of its outer edges, wherein the end face is arranged adjacent to the first mentioned one of the filter elements. When the filter elements are assembled in the filter housing as intended, the axially projecting lateral strip of the first mentioned one of the filter elements engages the groove of the seal of the other one of the filter elements.

In the proposed filter system, the two filter elements may be configured, for example, as flat filter elements; however, other filter element shapes are possible also. At least one of the filter elements is configured with a foamed-on seal. The end face edges of the filter body of the other one of the two filter elements are sealed by a glued-on lateral strip. In this context, the lateral strip is embodied so as to circumferentially extend around the entire circumference of the filter body. The lateral strip is arranged with an axial protrusion in relation to an end face of the filter element. The lateral strip is used in order to seal radially and/or axially against the foamed-on seal of the first filter element. Pressing the lateral strip against the seal surface of the seal is realized with assistance of the filter housing or of at least one housing part. In addition, a support structure, for example, of plastic material, may be arranged within the seal in order to increase the sealing force.

In axial direction, the seal may be compressed additionally by the filter housing or a housing part of the filter housing. In this way, a high seal tightness between the filter element and the filter housing is ensured.

Servicing of the particle filter element and of the adsorption filter element of a fuel cell system may be carried out separate from each other in this way, for example. Servicing costs may thus be beneficially reduced.

According to an embodiment of the filter system, the groove of the seal may include a seal surface which is oriented in radial direction against which the lateral strip rests seal-tightly. For example, when the filter housing is closed as intended, a collar of the filter housing may engage the groove of the seal and press the lateral strip against the seal surface. In this manner, a reliable sealing action between the two filter elements as well as in relation to the filter housing may be achieved.

As an alternative or in addition, the axially projecting lateral strip may extend to the base of the groove of the seal and axially seal against it.

According to an embodiment of the filter system, the seal is foamed onto the filter body. The seal may be directly foamed onto the filter body in this context. Beneficially, for example, polyurethane (PUR) may be used as a material in this context.

According to an embodiment of the filter system, the seal and the lateral strip may be pressed against a housing wall in an axial direction and/or in a radial direction when the filter housing is closed as intended. In this way, the seal and the lateral strip may be compressed axially and/or radially by means of the filter housing or by means of housing parts such as bottom part and top part in order to achieve a beneficial sealing action in this way.

According to an embodiment of the filter system, the seal may include a support structure which increases the sealing force. For example, the support structure may be embedded in the seal in this context. In this manner, a particularly safe sealing action of the two filter elements in relation to each other as well as in relation to the filter housing is achieved. The support structure may be formed of plastic material and, for example, may be embodied as an injection molded part. However, a metallic support structure, for example, in the form of a wire mesh or grid, is possible also.

According to an embodiment of the filter system, the filter element which is flowed through first in the flow direction may be designed as a particle filter. As an alternative or in addition, the filter element downstream in the flow direction may be configured as an adsorption filter, for example as an active carbon filter and/or as an ion exchanger. Particles as well as harmful gases may be filtered out of the intake air in fuel cell systems in this way, for example.

According to an embodiment of the filter system, the filter housing may encompass the seal at least in sections. For example, the filter housing may encompass the seal at the radially outer side. In this way, the seal may be protected from mechanical damage. In addition, the filter element may be centered in a radial position by the seal in this way so that the interaction of the seal of one filter element with the lateral strip of the other filter element is ensured in a beneficial manner. In addition, the sealing action of the filter elements in relation to the filter housing may be beneficially improved in this way.

According to yet another aspect of the invention, a first filter element for filtering a fluid, for example air, for a filter system is proposed, including a filter body including a filter medium which, when in use as intended, is arranged so as to allow passage of the fluid therethrough in a flow direction for flow-through. The filter body includes at an end face at outer edges a circumferentially extending seal with a groove in which, when assembled as intended, a lateral strip engages which projects at outer edges of an end face of another filter element.

Furthermore, a second filter element for filtering a fluid, for example air, for a filter system is proposed which, when in use as intended, is arranged so as to allow passage of the fluid therethrough in a flow direction for flow-through, wherein the filter element includes a circumferentially extending lateral strip which projects past an end face of the filter element in axial direction. The lateral strip is formed, for example, of a nonwoven, for example impregnated nonwoven, for increasing the stiffness. The lateral strip may be simply glued onto the filter body.

The proposed filter elements may be configured, for example, as a flat filter element, for example with rectangular cross section; however, other filter element shapes are possible also. The first filter element may be configured with a foamed-on seal which includes a groove which serves for sealing with the second filter element. The groove is configured axially upwardly open, viewed from the filter body. The end face edges of the filter body of the second filter element may be sealed by a glued-on lateral strip. The lateral strip may be arranged with an axial protrusion in relation to an end face of the filter element, wherein the lateral strip is configured to project axially along the circumference. In this way, the lateral strip may be used in order to seal radially and/or axially against the foamed-on seal of the first filter element. The protrusion of the lateral strip extends into the groove of the seal. Pressing the lateral strip against the seal surface of the seal may be realized with assistance of the filter housing or of at least one housing part. In addition, a support structure, for example, of plastic material, may be arranged within the seal in order to increase the sealing force. There is thus no separate seal, for example, PUR seal, arranged at the second filter element.

According to an embodiment, the one filter element may be configured as a particle filter and the other filter element as an adsorption filter, for example as an active carbon filter and/or as an ion exchanger. Particles as well as harmful gases may be filtered out of the intake air in fuel cells systems in this way, for example.

In this way, servicing of the particle filter element as one of the filter elements of a fuel cell system and of the adsorption filter element as the other filter element of the fuel cell system may be carried out separate from each other, for example. Servicing costs may thus be beneficially reduced.

According to an embodiment of the first filter element, the groove of the seal may include a seal surface which is oriented in a radial direction, and which is provided in order to be contacted seal-tightly by the lateral strip. For example, when the filter housing is closed as intended, a collar of the filter housing may engage the groove of the seal and press the lateral strip against the seal surface. As an alternative, the lateral strip may seal with its free end axially against the groove base.

According to an embodiment of the first filter element, the seal is foamed onto the filter body. Beneficially, for example, polyurethane (PUR) may be used as a material in this context.

According to an embodiment of the filter element, the seal may include a support structure which increases the sealing force. For example, the support structure may be embedded in the seal in this context. In this manner, a reliable sealing action between the two filter elements as well as in relation to the filter housing may be achieved. The support structure in this context is embedded in one of the stays of the groove, for example, in the radially inwardly positioned stay at which the lateral strip of the second filter element rests. In this way, the seal, when configured as a radial seal, may be particularly well supported.

### BRIEF DESCRIPTION OF THE DRAWINGS

Further advantages result from the following detailed description in conjunction with the accompanying drawings. In the drawings, embodiments of the invention are illustrated. The drawings and the detailed description contain numerous features in combination. A person of skill in the art will expediently consider the features also individually and combine them to expedient further combinations. It is shown in an exemplary fashion in:

FIG. 1 an isometric view of a filter system according to an embodiment of the invention;

FIG. 2 an isometric exploded illustration of the filter system according to FIG. 1;

FIG. 3 an exploded illustration of the filter system according to FIG. 1 in a side view;

FIG. 4 a view from above of the filter system according to FIG. 1 with marked section plane V-V;

FIG. 5 a section illustration of the section plane V-V according to FIG. 4 with marked detail VI; and

FIG. 6 an enlarged illustration view of the detail VI of the filter system according to FIG. 5.

### DETAILED DESCRIPTION

In the drawing figures, same or same-type components are identified with like reference characters. The drawing figures show only examples and are not to be understood as limiting.

Directional terminology used in the following with terms such as “left”, “right”, “top”, “bottom”, “in front of”, “behind”, “after”, and the like serves only for better understanding of the drawing figures and is not meant to represent in any case a limitation of the generality. The illustrated components and elements, their configuration and use may vary in the context of considerations of a person of skill in the art and may be adapted to the respective application.

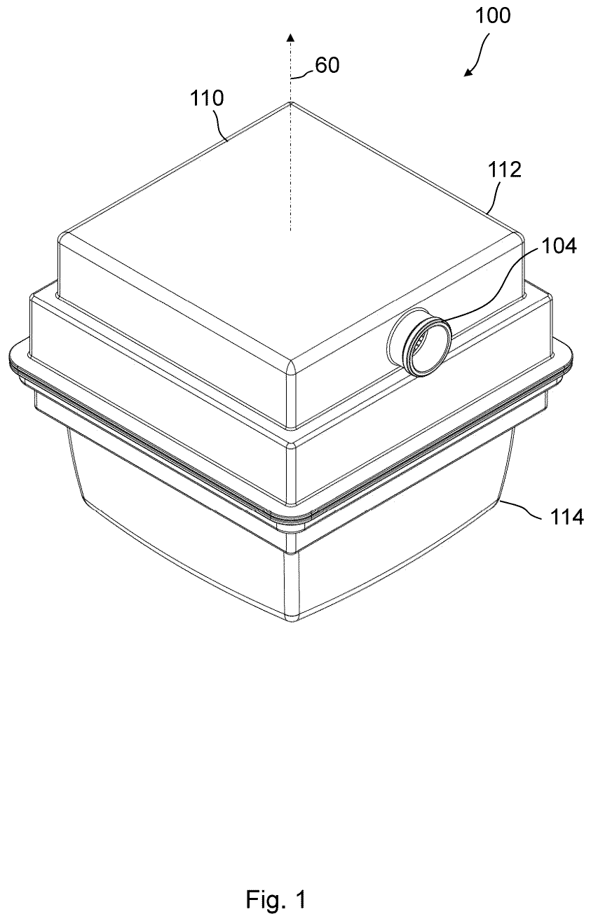

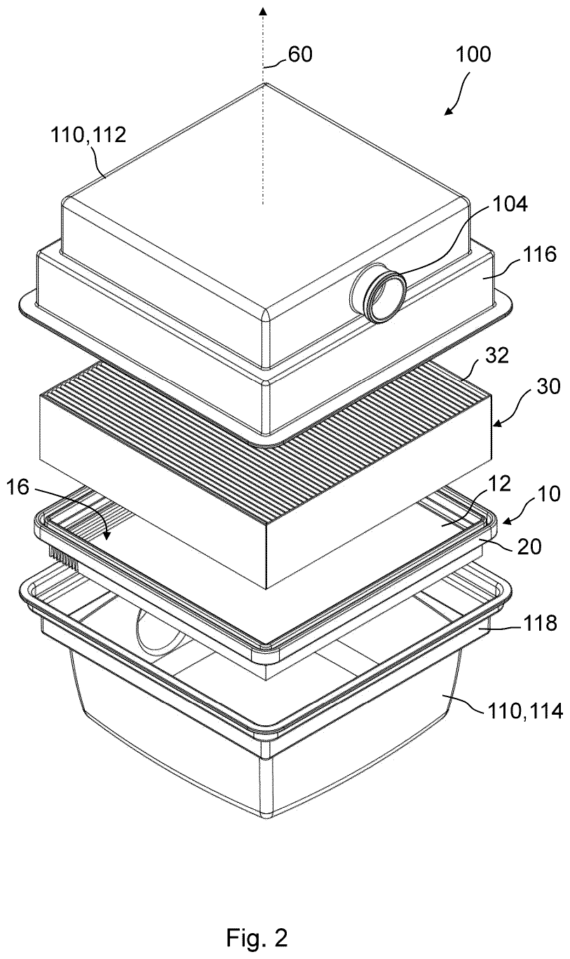

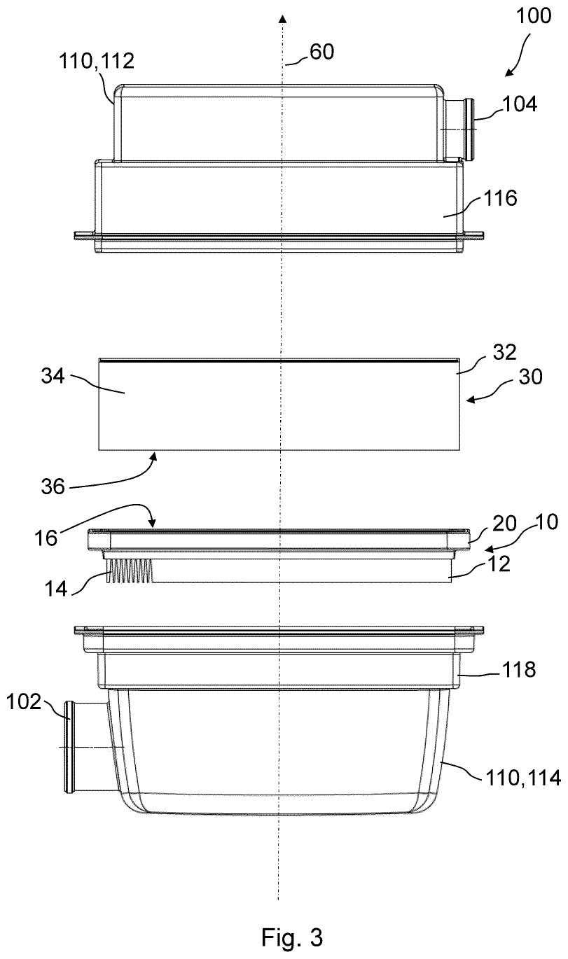

FIG. 1 shows an isometric view of a filter system 100 according to an embodiment of the invention. In FIG. 2, an isometric exploded view of the filter system 100 is illustrated, while FIG. 3 shows an exploded illustration of the filter system 100 in a side view.

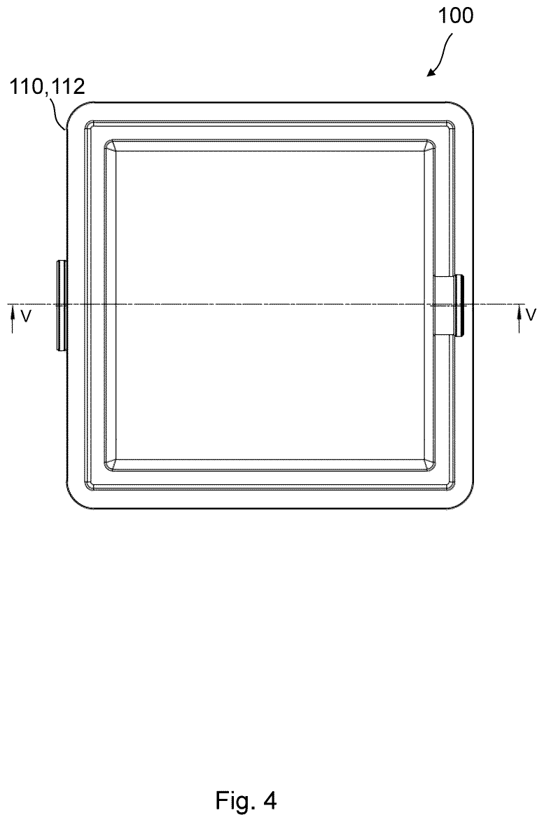

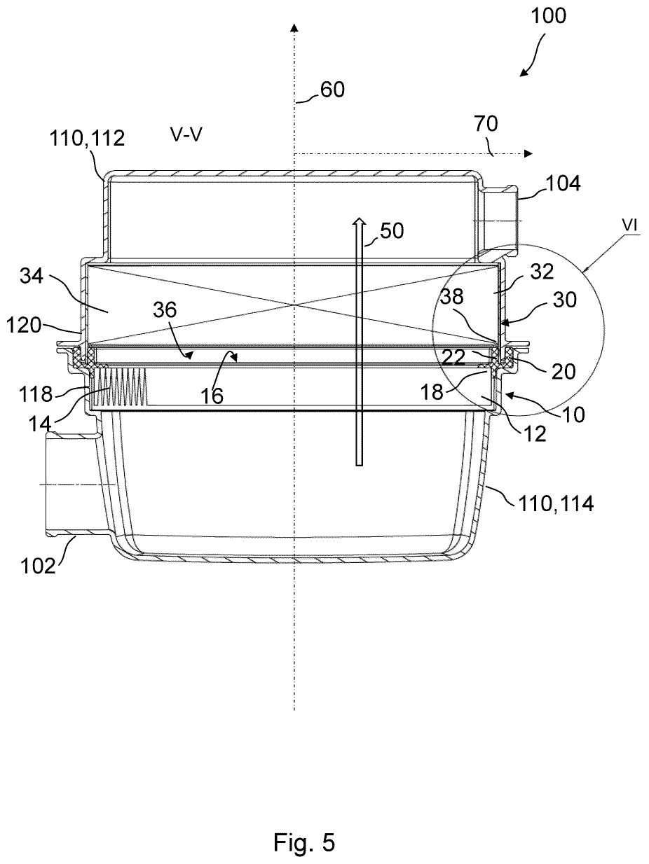

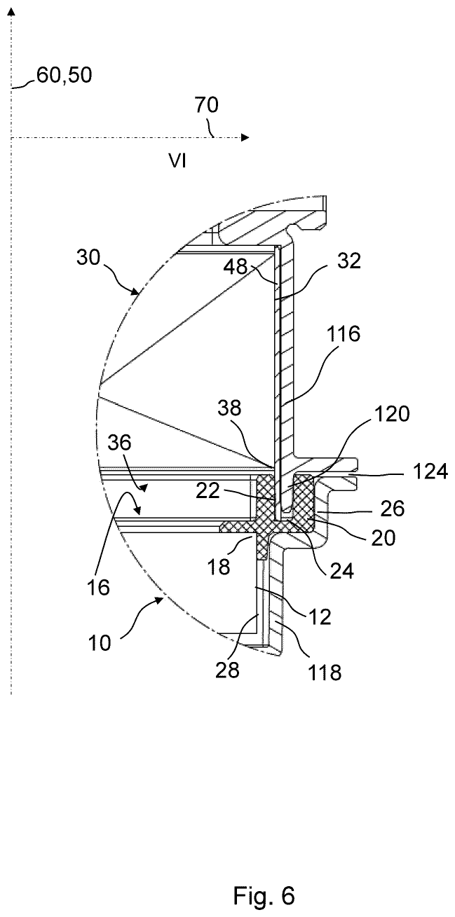

FIG. 4 shows a view from above of the filter system 100 with marked section plane V-V, wherein FIG. 5 shows a section view of the section plane V-V according to FIG. 4 with marked detail VI, and FIG. 6 shows an enlarged illustration of the detail VI of the filter system according to FIG. 5.

The filter system 100 comprises a filter housing 110 with a housing top part 112 having a housing wall 116 and a housing bottom part 114 having a housing wall 118, wherein a fluid inlet 102 (see FIG. 3) is arranged at the housing bottom part 114 and a fluid outlet 104 is arranged at the housing top part 112. The filter housing 110 is thus flowed through by the fluid to be filtered from the housing bottom part 114 to the housing top part 112 in a flow direction 50 (see FIG. 5).

As seen for example in FIGS. 2, 3, and 5, the filter system 100 comprises two exchangeable filter elements 10, 30 for filtering a fluid, for example for filtering air, which are arranged between the fluid inlet 102 and the fluid outlet 104. The filter elements 10, 30 each comprise a filter body 12, 32 with a filter medium 14, 34, which are arranged, when in use as intended, so as to allow passage of the fluid therethrough in the flow direction 50 for flow-through. The filter housing 110 flows through in an axial direction 60.

The filter medium 14, 34 may be embodied, for example, as a nonwoven or filter paper and arranged folded, for example folded in a zigzag shape, in the filter body 12, 32. In the drawing figures, folds of the filter medium are illustrated only partially in the filter body 12. Of course, the entire filter body 12 is embodied with the folded filter medium 14. The folds extend in this context between an inflow side and an outflow side of the filter bodies 12, 32, respectively.

One of the filter elements 30 comprises a lateral strip 48 (see FIG. 6) which projects in the axial direction 60 past an end face 36 of this filter element 30. The other one of the filter elements 10 comprises at an end face 16 a circumferentially extending seal 20 with a groove 24 which is arranged radially outside of its outer edges 18 (see FIG. 6).

When the filter elements 10, 30 are arranged in the filter housing 110 as intended, the end face 16 and the end face 36 are arranged so as to be axially opposite each other. The axially projecting lateral strip 48 of the first mentioned filter element 30 engages then the groove 24 of the seal 20 of the other one of the filter elements 10. The end face 16 of the filter element 10 forms the outflow side of the filter element 10 and the end face 36 of the filter element 30 forms the inflow side of the filter element 30.

The groove 24 of the seal 20 comprises a seal surface 22 which is oriented in a radial direction 70 and at which the lateral strip 48 rests seal-tightly. For example, a collar 120 of the filter housing 110 engages the groove 24 of the seal 20 and presses the lateral strip 48 against the seal surface 22 when the filter housing 110 is closed as intended.

Expediently, the seal 20 may be foamed onto the filter body 12. Expediently, in this context, polyurethane (PUR) may be used as a material, for example. The seal 20 engages with a first hold section an end face rim region and with a second hold section a lateral rim region, for example lateral strip 28, of the filter body 12 and is thus safely joined.

In an embodiment, not illustrated, the seal 20, when the filter housing 110 is closed as intended, may be optionally pressed against a housing wall 118 in the axial direction 60 and/or in the radial direction 70, whereby the sealing action of the filter elements 10, 30 in relation to each other and in relation to the filter housing 110 may be further improved. Furthermore, the lateral strip 48 may be designed such that it extends all the way to the groove base (as shown in FIG. 6) and here seals axially.

Beneficially, the seal 20 may have a support structure which increases the sealing force. For example, in this context the support structure may be embedded in the seal 20. The support structure thus supports the inner leg of the groove 24 of the seal 20. The support structure may also be embodied as a grid which extends across the end face 16 and comprises a circumferentially extending axial protrusion which is embedded in the seal 20.

The filter element 10 which is flowed through first in the flow direction 50 may be configured as a particle filter while the filter element 30 downstream in flow direction 50 may be embodied as an adsorption filter, for example as an active carbon filter and/or as an ion exchanger. Particles as well as harmful gases may be filtered out of the intake air in a fuel cell system in this way, for example.

As may be seen for example in FIG. 6, the filter housing 110 encompasses the seal 20 at least in sections at the radially outer side 26. In this way, the seal 20 may be protected from mechanical damage. In this way, the seal 20 is arranged in an at least partially closed seal chamber of the housing bottom part 114.

In addition, an interface 124 for connecting the housing parts 112, 114 may be arranged at the encompassment of the seal 20 so that removal of a filter element 10, 30 from the housing part 112, 114 is facilitated for servicing in this way.

### REFERENCE CHARACTERS

10 filter element
12 filter body
14 filter medium
16 end face
18 outer edge
20 seal
22 seal surface
24 groove
26 outer side
28 lateral strip
30 filter element
32 filter body
34 filter medium
36 end face
38 outer edge
48 lateral strip
50 flow direction
60 axial direction
70 radial direction
100 filter system
102 fluid inlet
104 fluid outlet
110 filter housing
112 housing top part
114 housing bottom part
116 housing wall
118 housing wall
120 collar
124 housing interface

What is claimed is:

1. A filter system comprising a filter housing with a fluid inlet and a fluid outlet, and comprising at least two exchangeable filter elements for filtering a fluid arranged between the fluid inlet and the fluid outlet;
wherein the filter elements each comprise a filter body comprising a filter medium arranged so as to allow passage of fluid therethrough in a flow direction for flow-through;
wherein one of the filter elements comprises an axially projecting lateral strip which projects past an end face of the one of the filter elements in an axial direction;
wherein the other one of the filter elements comprises at an end face a circumferentially extending seal with a radially outer groove, wherein the end face of the other one of the filter elements is arranged adjacent to the end face of the one of the filter elements;
wherein, when the one of the filter elements and the other one of the filter elements are assembled in the filter housing, the axially projecting lateral strip of the one of the filter elements engages the groove of the seal of the other one of the filter elements.

2. The filter system according to claim 1, wherein the groove of the seal comprises a seal surface oriented in a radial direction at which the axially projecting lateral strip rests seal-tightly when the filter housing is closed, and wherein a collar of the filter housing engages the groove of the seal and presses the axially projecting lateral strip against the seal surface.

3. The filter system according to claim 1, wherein the axially projecting lateral strip is in contact with a base of the groove and is axially compressed.

4. The filter system according to claim 1, wherein the seal is foamed onto the filter body of the other one of the filter elements.

5. The filter system according to claim 1, wherein the seal is compressed against a housing wall of the filter housing in the axial direction and/or in a radial direction.

6. The filter system according to claim 1, wherein the seal comprises a support structure embedded in the seal which increases a sealing force.

7. The filter system according to claim 1, wherein the one of the filter elements which is flowed through first in the flow direction is configured as a particle filter and/or wherein the other one of the filter elements downstream in the flow direction is configured as an adsorption filter.

8. The filter system according to claim 1, wherein the filter housing at least in sections encompasses the seal.

9. A filter element for filtering a fluid, comprising a filter body comprising a filter medium arranged so as to allow passage of the fluid in a flow direction for flow-through;
wherein the filter body comprises at an end face a circumferentially extending seal with a radially outer groove that engages with an axially projecting lateral strip of an end face of another filter element.

10. The filter element according to claim 9, wherein the groove of the seal comprises a seal surface which is oriented in a radial direction and which is provided such that the axially projecting lateral strip rests seal-tightly against the seal surface when a filter housing is closed, and wherein a collar of the filter housing engages the groove of the seal and presses the axially projecting lateral strip against the seal surface.

11. The filter element according to claim 9, wherein the seal is foamed onto the filter body.

12. The filter element according to claim 9, wherein the seal comprises a support structure embedded in the seal which increases a sealing force.

13. The filter element according to claim 9, configured as a particle filter and/or as an adsorption filter.

14. A filter element for filtering a fluid, comprising a filter body comprising a filter medium arranged so as to allow passage of the fluid in a flow direction for flow-through, wherein the filter element comprises a circumferentially extending and axially projecting lateral strip which projects past an end face of the filter element in an axial direction.

15. The filter element according to claim 14, wherein the circumferentially extending and axially projecting lateral strip is embodied of a nonwoven.

16. A use of the filter system according to claim 1, as a cathode air filter in a fuel cell system.
